(19) United States
(12) Patent Application Publication
(10) Pub. No.: US 2007/0050149 A1
(43) Pub. Date: Mar. 1, 2007

(54) Method for Modeling, Analyzing, and Predicting Disjunctive Systems

(76) Inventor: Michael Raskin, Somerville, MA (US)

Correspondence Address: MIRICK, O'CONNELL, DEMALLIE & LOUGEE, 100 FRONT STREET, WORCESTER, MA, 01608, US

(21) Appl. No.: 11/465,886

(22) Filed: Aug. 21, 2006

Related U.S. Application Data
(60) Provisional application No. 60/710,497, filed on Aug. 23, 2005.

(51) Int. Cl. G06F 19/00

(52) U.S. Cl. 702/19

(57) ABSTRACT

A method for analyzing and forecasting complex disjunctive systems, which is thus particularly suitable for handling human behaviors.

### CROSS REFERENCE TO RELATED APPLICATION

The application claims priority of a Provisional application Ser. No. 60/710,497, filed on Aug. 23, 2005, which is incorporated herein by reference.

### FIELD OF THE INVENTION

This invention relates to a method for modeling, analyzing, and predicting disjunctive systems such as found in human behavior.

### BACKGROUND OF THE INVENTION

Human behavior has a large disjunctive component, that is, the same thing happens in different ways. People buy the same product, choose the same profession, make the same investments, support the same candidates, and so forth for reasons of their own, and they come to these decisions through different experiences. For any individual and any behavior, the particular combination of reasons and experiences is likely to only partially overlap that of the next person,

Conventionally, quantitative methods for analyzing and forecasting human behavior have sought to explain the same or similar behaviors in the same way, in spite of the diversity that can be observed. Thus we see prediction models taking the classic y=f(x) form, as in applications of GLM (general linear models) such as regression and ANOVA. To find coherent y's and x's, these models pare down variables to relevant common factors. For example, if we were looking for environmental factors affecting a mental illness, y would be the symptoms patients have in common, and the x's would be the factors which regularly showed up in their case histories. Only overlap counts. This signal and noise approach throws away a great deal of information. Moreover, it converts observed relationships, which are best described by a disjunctive formulations, If X₁ or X₂ or X₃ or . . . or Xₙ then Y, to conjunctive formulations, If X₁ and X₂ and X₃ and . . . and Xₙ then Y.

Thus conventional analysis (and experimental and quasi-experimental design) begins by discarding relevant information and employing a conjunctive explanatory model when observation often indicates a disjunctive model is more appropriate. There are numerous reasons for these practices, ranging from the scientific ideal of building parsimonious (explain the most with the least) models to sheer practicality. Disjunctive models based on combinations of variables are apt to be enormous, and there are currently few statistical tools designed to make sense of them.

### Context

### Mechanisms

### Mentality

Unlike the physical world that the natural sciences have generally studied, the human world does not respond directly to physical forces. It responds to information—and much of what we respond to does not exist except as information. I do not, for example, own a car unless I and/or other people think I do; I am not married or divorced unless I and/or other people think I am; music is not beautiful unless I and/or others thinks so; I am not a citizen of the United States unless I and/or other people think so, and so on. We exist in a world defined by information, by what is in our minds.

The result is that relationships and properties, like the minds that contain them, are diverse and malleable. In input-output terms: A can lead to different B's, different A's can lead to the same B, and these linkages are apt to vary across people, circumstances, and time. Unlike physical forces, psychological and social forces do not force things.

In his 1984 Reith lectures John Searle argues that the mental character of psychological and social phenomena create a radical discontinuity between the social and physical sciences.
For a large number of social and psychological phenomena the concept that names the phenomena is itself a constituent of the phenomenon. In order for something to count as a marriage ceremony or a trade union, or property or money or even a war or revolution people involved in these activities have to have certain appropriate thoughts. In general, they have to think that's what it is. So, for example, in order to get married or buy property you and other people have to think that that is what you are doing. Now this feature is crucial to social phenomena. But there is nothing like it in the biological and physical sciences. Something can be tree or a plant, or some person can have tuberculosis even if no one thinks: ‘Here's a tree, or a plant, or a case of tuberculosis’, and even if no one thinks about it at all. (John Searle, Minds, Brains, and Science (Cambridge: Harvard University Press, 1984, p. 78). Searle also argues that there cannot be any strict ‘bridge principles,’ from physical states to mental ones because there are no physical limit on what entities like ‘money,’ ‘married,’ and so forth.)

This passage is on the way to arguing that the social sciences must be sciences of intentionality. Searle defined intentionality as “the feature by which our mental states are directed at, or about, or are of objects or of states of affairs other than themselves. ‘Intentionality’ refers to beliefs, desires, hopes, fears, love, hate, love, disgust, shame, pride, irritation, amusement, and all of those mental states (whether conscious or unconscious) that refer to, or are about, the world apart from our mind.” (p. 16). The argument herein goes in a different direction. It is that, in Searle's phrase, “the intrinsically mental character of social and psychological phenomena.” (p. 84) allows the human world to be built with mechanisms that would be both implausible and inefficient—that would hardly make sense—in a world that is purely physical. These mechanisms create a second ‘radical discontinuity’ between the physical and social sciences.

### Combinations, Uncertainty, and Disjunctive Explanation

Consider a few of the factors that affect the likelihood of a decision maker pursing a business acquisition. Gaining customers, blocking competitors, diversifying the product set, complementing the product set, building one's personal empire, revenue growth, margin enhancement (synergy or acquiring more profitable business), consistency with larger corporate strategy, pleasing Wall Street, pleasing investors, and obtaining new technology. While a decision maker may pursue an acquisition in response to only one of these factors, it is more likely to be some combination.

Taken singly and together these eleven factors form 2048 different combinations, and every combination is, potentially, a reason to pursue an acquisition. For example, one reason for pursuing an acquisition is a combination of gaining customers, diversifying the product set, revenue growth, and pleasing the boss, but none of the rest. Another example is the combination of blocking competitors, complementing the product set, building one's personal empire, pleasing Wall Street, and obtaining new technology, but none of the rest. While there must be decision makers who wouldn't pursue an acquisition for any of the two thousand plus reasons, and there might be decision makers who would pursue it for every one of them, for most decision makers there will be a number of combinations of factors that could lead them to pursue an acquisition. For some it might be just a few and for others hundreds or more—if not from this list, then from another and more complete one.

Note that capability to do the same thing for such a variety of reasons is a consequence of “the intrinsically mental character of social and psychological phenomena.” Causal linkages are a matter of what we think rather than the direct effects of physical forces.

In Model 1 (below) we see a diagram of a simplified version of the situation we have been describing. It has only two of the eleven factors and therefore only four combinations forming reasons to do an acquisition. These four will stand in for the 2048. These factors, to take two more or less at random, are Gaining Customers and Pleasing Investors, along with their complements, Not Gaining customers and Not Pleasing Investors. The four combinations serving as reasons to do an acquisition are:
1. Gaining Customers and Pleasing Investors
2. Gaining Customers and Not Pleasing Investors
3. Not Gaining Customers and Pleasing Investors
4. Not Gaining Customers and Not Pleasing Investors

Model 1, a conventional probability tree, shows the possibilities that result. Probabilities of each branch have been assigned for the purposes of exploring the example.

Model 1

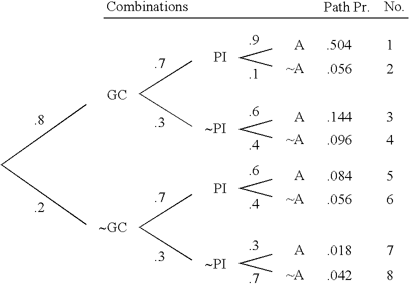

The model shows the eight possibilities that arise from the four combinations of the two factors (resulting in eight paths because each of the four combinations leads to two outcomes: Acquisition and Not Acquisition). A path running from left to right represents each possibility. For example, Path 6 represents the combination of Not Gaining Customers and Pleasing Investors Not leading to pursuing the Acquisition. The probabilities along the branches are the likelihood those factors will be present and lastly, the Path Probability, of pursuing an acquisition occurring given those factors. The final column is simply the path numbers.

Path probabilities are the product of the probabilities of the factors along it. The probability of Path 1, for example, is
P(GC)×P(PI|GC)×P(A|GC&PI)=0.8×0.7×0.9=0.504

Since pursuing an acquisition could happen in any of ways shown by the four paths that lead to it, its probability is the probability that Path 1, or Path 3, or Path 5, or Path 7 occur—which (since they are mutually exclusive) is simply the sum of their probabilities.
P(Path 1)+P(Path 3)+P(Path 5)+P(Path 7)=0.504+144+0.084+0.018=0.75

The result in this simplified example is that pursing the acquisition, with a probability of 0.75, is fairly likely even though the highest probability of any the reasons for it (any path) has a probability around 0.5, and the least probable has a probability of only around 0.02. In a more realistic tree, with hundreds or thousands of paths, quite probable outputs could arise from the sums of the probabilities of quite improbable inputs. Consistencies built on inconsistencies—in effect, strong castles built on shifting sands. More conventional methods, which look for input consistencies to build upon, are apt to miss what is going on.

The logic of this pluralistic mechanism is disjunctive, based on asserting that the outcome arises from A or B or C or . . . or N. (In this case where each term represents a path.) This is in contrast to the more conventional explanatory logic, which is conjunctive, based on asserting that the outcome arises from A and B and C and . . . and N. This difference is not whether there are multiple causes, or more than enough reasons for a behavior, but the logic of how a behavior is produced.

The argument for the necessity of disjunctive mechanisms—many ways to the same end created by the multiplicity of combinations—in explaining predictable human behavior can also be made by considering the difficulty in explaining human behavior in its absence. Table 1 shows the maximum probabilities of paths with from two to twenty factors, where the factor's average probability runs from 0.7 to 0.995, illustrating how difficult it is to produce a viable conjunctive explanation: individual paths that can account for even moderately high probabilities. Note that the probability calculations throughout assume the probabilities are the appropriate conditional probabilities for the calculations. This assumption greatly simplifies the discussion, and removes the limitation of assuming the probabilities are independent.

If we wish, for example, to explain a behavior whose probability is just 0.57 with a single path of eleven factors, their average probability must be at least 0.95. While many factors affecting human behavior are that probable, or even more probable, most are not. The difficulty is the uniformity required: in a single path explanation every one of the factors must be close to that probable. Such uniformity is too stringent a requirement for explaining most human behaviors, as considering the range of probabilities likely among the factors influencing behavior. The explanatory weakness of individual paths gives us little alternative but explanations that build on the contributions of multiple paths.

TABLE 1
Path Probabilities

| | | Minimum Average Probability of Factors | | | | | | | | | |
|---|---|---|---|---|---|---|---|---|---|---|---|
| | | .995 | .99 | .97 | .95 | .93 | .90 | .85 | .80 | .75 | .70 |
| Number | 2 | .990 | .980 | .941 | .903 | .865 | .810 | .723 | .640 | .563 | .490 |
| of | 3 | .985 | .970 | .913 | .857 | .804 | .729 | .614 | .512 | .422 | .343 |
| Factors | 4 | .980 | .961 | .885 | .815 | .748 | .656 | .522 | .410 | .316 | .240 |
| | 5 | .975 | .951 | .859 | .774 | .696 | .590 | .444 | .328 | .237 | .168 |
| | 6 | .970 | .941 | .833 | .735 | .647 | .531 | .377 | .262 | .178 | .118 |
| | 7 | .966 | .932 | .808 | .698 | .602 | .478 | .321 | .210 | .133 | .082 |
| | 8 | .961 | .923 | .784 | .663 | .560 | .430 | .272 | .168 | .100 | .058 |
| | 9 | .956 | .914 | .760 | .630 | .520 | .387 | .232 | .134 | .075 | .040 |
| | 10 | .951 | .904 | .737 | .599 | .484 | .349 | .197 | .107 | .056 | .028 |
| | 11 | .946 | .895 | .715 | .569 | .450 | .314 | .167 | .086 | .042 | .020 |
| | 12 | .942 | .886 | .694 | .540 | .419 | .282 | .142 | .069 | .032 | .014 |
| | 13 | .937 | .878 | .673 | .513 | .389 | .254 | .121 | .055 | .024 | .010 |
| | 14 | .932 | .869 | .653 | .488 | .362 | .229 | .103 | .044 | .018 | .007 |
| | 15 | .928 | .860 | .633 | .463 | .337 | .206 | .087 | .035 | .013 | .005 |
| | 16 | .923 | .851 | .614 | .440 | .313 | .185 | .074 | .028 | .010 | .003 |
| | 17 | .918 | .843 | .596 | .418 | .291 | .167 | .063 | .023 | .008 | .002 |
| | 18 | .914 | .835 | .578 | .397 | .271 | .150 | .054 | .018 | .006 | .002 |
| | 19 | .909 | .826 | .561 | .377 | .252 | .135 | .046 | .014 | .004 | .001 |
| | 20 | .905 | .818 | .544 | .358 | .234 | .122 | .039 | .012 | .003 | .001 |

Table values are path probabilities

Although we have only sketched in the features of disjunctive explanations, their key virtues have been suggested. Disjunctive explanations, grounded equally in everyday observation (of the multiplicity of ways things happen) and mathematics, offer a general understanding of human behavior that embraces rather than struggles with uncertainty, diversity, large numbers of factors, and the individuality of our minds. They build on the flexibility of our minds, the capability to mentally link different inputs with a single output. They have no difficulty with behaviors that are produced by different and shifting reasons across time and circumstances, and they are more than at home in a world in large part defined by mental constructs. In short, disjunctive explanations offer a mathematically sound general model that fits the human world very well.

Other Examples

We have used business acquisitions as an example of a phenomenon best explained by a disjunctive model, but it should be apparent the same case can be made for a wide variety of other psychosocial phenomena. All it takes is listing the variety of factors that can influence the likelihood of a behavior, given that various combinations of these factors can serve as reasons for that behavior.

Other examples are easily constructed. Reasons to go to a movie made from factors like friends have asked you to go, having read good reviews, not wanting to stay at home, because all the cool people are seeing it, because you have a free pass that is about the expire, because you like the star, and so on. Reasons to hold a particular job, including factors like it pays adequately, that we enjoy colleagues, that it is an easy commute, that we don't know of a better alternative, that we can get away with slacking off, it keeps us out of the house, it has good opportunities for advancement, we like the work, we can steal office supplies, and so on. Reasons to get married, made from factors like wanting children, physical attraction, wanting to get away from home, religious beliefs, everyone else is doing it, financial security, friendship, status, and so on. Reasons to go to war, made from factors like fulfilling treaty obligations, responding to an attack, gaining an advantage over domestic political rivals, maintaining control of foreign markets, for the sake of ideological convictions, to establish a country as a first rate military power, to maintain the current balance of power, and so on. Just as in the marriage example, the number of combinations that can lead to an outcome can easily number in the thousands.

The reasons just mentioned are all familiar parts of conventional and sometimes competing explanations. But here they are understood as creating a variety of possibly improbable paths to the same behavior, and that it is the sum of the path probabilities that explains that behavior. Thus we have no need to rely on conventional ways of dealing with the observed diversity of reasons for behavior: looking for common factors or working in abstractions that gloss over observed differences. The diversity of reasons is the explanation.

Efficiency and Robustness

Why would the human world be organized in this complicated way? Why do the same thing in many ways that can be done in one? Wouldn't one best way make more sense? The simple answer is something like, because we can—or less cavalierly, because, given human mental capabilities, pluralistic mechanism is an effective adaptation.

There are two ways to produce reliable outputs facing unreliable inputs: either minimize unreliability by altering the inputs or being selective in their use, or, as in the pluralistic model, capitalize on the likelihood that one of a number of ways to produce the output will occur. With physical mechanisms, reducing unreliability in the inputs is generally the most efficient method of obtaining reliability. We have a long history of success in making reliable devices by insuring that their components are reliable under normal operating conditions. (And a long history of sciences that have succeeded by finding structures built on reliable behaviors in nature.) Capitalizing on disjunctive arrangements, which require maintaining duplicates, monitoring performance, and some method of relatively seamless switching, is expensive. For that reason it is largely reserved for critical applications such as redundant aircraft control systems or emergency hospital power supplies.

In the human world, however, we have not had similar success with minimizing unreliability, especially in the longer term. Our techniques for minimizing unreliability in human behavior: such as rewards and punishments, education and training, social and economic nouns and pressures, ethical and moral codes, and coercion, along with selection mechanisms such as grading, certification, hiring and firing, are useful but not consistently effective. Their effects are far from ‘lawful.’ So, while some behaviors are reliable—for instance, in the all the years I have been going to my local grocery I have never seen a cashier reject appropriate payment—many behaviors are neither so reliable nor readily made so reliable. Compared to machines, the mechanisms of the human world are apt to be built on relationships and properties whose probabilities are lower and more variable.

But in the human world, disjunctive arrangements can be made of reasons for doing things which tap nothing more in the way of resources than the mental capacity to do something for more than one reason, and draw on the ready made combinations inherent in the multiplicity of reasons we do things. In contrast to a more mechanically driven world, they can be had, in effect, on the cheap. It is hard, given how easily we do the same thing for different reasons and the presence of so many combinations, to see how these redundancies can be avoided. So in the human world the two routes to producing reliable outputs from unreliable inputs are both viable, and it would be arbitrarily limiting if an adaptive system relied on just one.

Evolutionary logic is the logic of what survives. The forces that have powerful uniformity creating effects, arising from such things as the struggle for survival in a marginal economy, the coercion and social pressures of totalitarian states and other rigid organizations; powerful incentives such as opportunities for rapid acquisition of wealth in a speculative boom; or high morale and closely knit groups, tend to come apart. As people succeed in improving the economy, as the rigidity of a social system is subverted as people discover ways to avoid its strictures and corrupt its powers towards their own ends, as the boom plays out, as the closely knit group unravels as other interests and affections intrude, the few forces which drove behavior lose much of the potency. In short, these forces, as powerful as they can be in limited time periods and particular circumstances, are unreliable outside of those limits. For a cultural pattern, a social institution, or a personal characteristic to persist across time and circumstances, its survival is apt to be better explained by how it capitalizes on, rather than fights, our diverse and changeable nature.

### SUMMARY OF THE INVENTION

The invention (sometimes herein referred to as “Probability Mapping” or “PM”) provides a means of making analysis and forecasting of disjunctive human systems practical. This allows it to take advantage of the information conventional methods are forced to discard, and use more realistic and comprehensive causal models, resulting in more informative analyses and reliable predictions.

Probability Mapping automatically maps the diversity of behaviors and multiplicity of factors directly from data as networks of probability relationships, and then addresses queries to those maps instead of directly to the underlying data. The maps are extensions of conventional probability trees, which are made accessible despite their complexity by a suite of analytic tools.

The maps are constructed using three simple devices: two are familiar although not usually combined, while the third violates a standard precept of statistical analysis.

The devices are,
1) Look-ups in a database using standard logical operators (AND, OR, NOT, which return a true or false value). Given a properly structured database, probabilities can be measured by counting “true's” returned to a logical query that describes the conditional relationship in question (and dividing by an appropriate N). The database is structured such that conditioning relationships proceed from left to right (or equivalent).
2) Probability trees to describe a system with uncertain components
3) Segmenting continuous variables to produce discrete variables, where different segmentations can be used simultaneously to capture the multiplicity of dimensions the variable may contain (The conversion of continuous to discrete variables, in covariance based statistics, is understood as throwing away information and statistical power, but it plays the opposite role here.)

These three devices allow producing a map of events that lead to outcomes, in the form of a conventional probability tree. The map shows the probability of each event and of each path, and the sum of the probabilities of sets of paths leading to outcomes. Thus we have a picture of the various ways to get from inputs to an output, in however many ways the output is reached, along with the various relevant probabilities.

Because PM's underlying mathematics is counting and simple arithmetic, and because interpretation is based on measures of probability, which can be thought of as the percentage of times an event is likely to happen, PM is extraordinarily robust and its measures interpretable.

The invention comprises methods of analyzing and predicting the disjunctive systems, especially human behaviors, which are inadequately handled by conventional methods.
It is usable by analysts and business people without statistical training. The only technical element confronting the user, probabilities, can be understood as percentages.
The interface is fairly close to a natural language, and to inquiries we make in everyday attempts to formulate decisions and policies, such as “what happens in this situation?” or “what is a way to make some outcome more likely?” rather than questions more along the lines of, “what is the relationship between variables?”
It treats a data set comprehensively. Instead of using the database as a resource for selected analysis, it makes a map of the probability relationships in the entire database before analysis begins. Its analyses produces reports on the relevant features of the map, and unless restricted by the user, considers the map as a whole.
Comprehensiveness allows identifying system wide effects, both intended effects and side effects.
It makes a complex world accessible without simplifying it. It focuses on answering questions about the effect of events acting within it, rather than trying for a general model of accessible overall understanding.
It can forecast the results of differing situations without reanalyzing the data (the Map contains forecasts from all combinations of variable states).
PM forecasts outcomes in disjunctive systems more accurately than conventional methods because it does not work with summaries, piecemeal analyses, or functions which collapse the diversity of ways outcomes occur.
By measuring outcomes in probabilities and (using a module) expected values, it works in terms that businesses can directly apply to decisions.
PM allows isolating variables that are controllable (using a module) to analyze what can be done with them, to utilize measures of the cost of making changes in these variables, and develop recommendations based on these analyses. It looks, not just at selected relationships, but at the consequences of relationships in the context of a larger system.
It allows for multidimensional segmenting of continuous variables, and multidimensional categorical variables, by describing both with as many parallel categorizations as the substance requires. For example, income can be described with percentiles; by whether it places people as poor, middle class, upper income; relative to a different group; and so on. There is no technical limit to the number of categories that might be used. The limitation on the proliferation of categories is substantive, and depending upon event altering the probability of outcomes.
PM captures the cumulative impact of small effects that would be missed in traditional statistical analysis.
In theory, conventional methods can be used to develop a comprehensive view, track disjunctive relationships, use multiple dimensions, capture small effects, albeit with some, and sometimes serious, technical limits, but for the most part the effort required makes the attempt wholly impractical—especially in business or practical policy making setting where there is limited capability to deal with technical issues. And asking the right questions to generate the analyses that capture these effects would take knowledge that conventional techniques do not readily provide. It is, in effect, working them against the grain.
Probability Mapping is mathematically robust. Because it is based on logical operations and arithmetic, it requires no distributional and a minimum of scalar assumptions.

### Data for the Invention

1. Conventional statistical methods are most effective when handling continuous variables, kept in continuous form. Information is considered lost when data is converted from continuous to categorical form. Also, it is a common practice, for example in measures of judgments such as approval/disapproval rating, to use discrete anchors and convert them into numbers treated as points on a continuous scale. In contrast, PM works with discrete variables, and converts continuous variables to discrete forms. The substantive reason is that people respond to categorizations of continuous variables. For example, they don't respond directly to incomes numbers but to judgments about what those incomes represents, such as too little to live on, wealthy, more than they deserve, and so on. The predictors that best capture the factors motivating behaviors, since they are based on these judgments, are apt to be categorical.
In addition, continuous variables are likely to contain a variety of such discrete categorizations. Categories which divide up continuous variables be drawn differently, such as what might be judged as wealth, and are likely to vary from person to person and across time and circumstances. In short, they are apt to contain multiple dimensions. PM uses multiple categorizations, as many as prove informative. This would not be possible in conventional statistical analysis due to the technical limitations associated with highly correlated variables.
Working in categoric variables allows a straightforward approach to calculating probabilities.
2. The basic row by columns (variables by cases) database is structured to represent conditioning relationships (nominally from left to right).
3. The process of converting continuous variables to discrete variables, here called segmenting, is supported by an Event Contribution measure that determines if a particular segmentation is informative. That is, if it makes a difference in the probability of selected output variables.
(Determination of an informative set of discrete variable, the number of segments in each variable, and their dividing points is supported by an automated process that seeks an optimal configuration.)
4. The segmenting process, although a part of building the PM, is informative in itself. It defines categorizations that influence behavior with respect to selected output variables.

### The Model for the Invention

1. Probability Mapping is designed in recognition of the large role of disjunctive systems in human behavior.
2. Its internal model does not rely on commonalities in the set of variables that lead to the outcome, nor a shared underlying functional form.
3. A map, as opposed to functions, is an appropriate representation of a disjunctive system since it can represent input to output (start to finish) paths that do not have common elements or work on the same underlying principles.
4. Analysis and forecasting is not performed from raw data but from the conditional probability relationships—the map—contained in the data.
5. The map of probability relationships is generated from the data automatically.
6. The internal representation of behavior, the map, is logical: a collection of paths with a one thing leads to another structure (a temporal sequence is not assumed). The result is a map of routes. There are no equations representing behaviors.
7. The measure of the strength of relationships is probabilities rather than, as is more conventional, measures of deviation (percentage increase or decrease, zscores, etc.) or covariation (correlations, R², etc.). For practical and predictive questions the issue is likelihood. We want to know what will happen given a situation. Likelihood is measured by probability.
8. The model calculates the cumulative effect of these paths on the probability of outcomes. It does not choose a single, or set oft best predictors. It uses the entire map. This allows accounting the effect of numerous and relatively unlikely events, as well as small numbers of more likely ones. These can make a large contribution to explaining and predictive behavior.
9. Compared to other measures of effect size, probabilities are readily interpretable, in part because they are an absolute quantity (unlike measures of covariation which measures predictability relative to that only using information about the value of the response variable, or deviation, which is also a comparison) and in part because they can be understood simply as the percentage of cases in which a behavior is expected to occur.
10. The probability calculations used are arithmetic, so they are robust and free of distributional assumptions.
11. The model includes no implicit substantive assumptions about human behavior. It allows accounting for disjunctive as well as conjunctive structures, regardless of the reasons for them.
12. Conventional models often make a signal and noise distinction and need to discount outliers. Probability Maps need neither device.
13. Sequence is an integral part of the model.
14. It can distinguish logical relationships of necessary and sufficient (at various levels of probability).
15. Variables states (events) can be interpreted locally, in the context of the other events on the same path. This within path interpretation allows a more nuanced definition of terms than conventional models, which rely on a single definition throughout. Also, it parallels the everyday use of context to define terms. This makes the model more accessible, not only by the familiarity of the method of interpretation, but by lessening the reliance on formal and abstract definitions.

### Analysis and Prediction for the Invention

1. Probability Mapping includes a suite of analytic tools which allow making inquiries using logical operators. These inquiries measure the influence of events and paths on outcomes.
   a. Selection tools allow selecting either parts or the whole map for analysis
   b. Inquiry tools allow analyzing the effects of events and paths on outcomes (including forecasts) and facilitate selection for further analysis.
2. The inquiries typically produce responses that list events and/or paths in the rank order of their influence on outcome probabilities, those probabilities, and related graphics.
   a. In the case of paths and combinations of paths, the primary measure, path contribution, is a measure of the contribution of a path or set of paths to an outcome's overall probability
   b. In the case of an event and combinations of events, the primary measure, incremental event contribution, is a measure of the difference in outcome probability between when an event or set of events occurs and does not occur.
3. Forecasts are based on ‘situations.’ For any event, its situation is defined by the prior path (the events that have led up to, or more accurately, condition, it), and the consequences of the situation by the subsequent paths (the probability distribution of outcomes).
   a. Event Contribution (the probability of an outcome given the event) is calculated for every event in a map. Thus for every situation, the predicted (from observation) likelihood of an outcome is defined.
   b. The availability of event contribution numbers allow defining logical searches seeking prior paths that maximize or minimize outcomes and match user selected criteria defining prior paths (the situation). That is, we can ask, what changes would produce the greatest result, restrict our search to practical and/or expected changes, and obtain an answer rank ordered by the predicted magnitude of impact (or, with an additional module, other criteria).
   c. Path contribution and Path Potential (the probability of the outcome given the path) is also calculated for every path in the map. Thus each combination of events that leads to an outcome is predefined.
   d. The availability of path potential contribution numbers allows defining logical searches seeking the combinations and sequences of ways outcomes occur or do not occur. This information is what we generally seek when asking how something happens, or what methods have proven their feasibility. The answers are rank ordered by magnitude (or, with an additional module, other criteria).
4. In the use of these measures, and in particular, the Situation Change ranking, which ranks the number of changes necessary to meet a criteria, beginning with the fewest, such as maximizing outcome probability (either path contribution or path potential), there is an empirically grounded What-If capability.
5. Others measures allow further definition of the role of events and paths in disjunctive systems.
6. A collection of modules allow using Probability Mapping to classify events by multiple criteria to allow working with selected groups of events; calculate expected values; support decision making engines, such as stock portfolio choices; and do sensitivity analysis and agent based simulations.

### Applications for the Invention

Probability Mapping supplements, and particularly for practical applications, largely replaces conventional statistical methods when applied to disjunctive human phenomena, and within that realm its range of applications should be at least as broad. In that disjunctive realm—because PM uses more of the information available and imposes less restrictive assumptions on the relationships it can handle—its predictive and analytic powers should be reliably greater than that of conventional techniques.

Forecasting applications in commercial areas include stock market forecasts (the probability of obtaining a level of performance or of slope change), marketing forecasts, predicting loan defaults, forecasting the effects of medical interventions with differing effects depending on the conditions and sequence of application, and other domains where outcomes arise in a variety of ways.

Operational applications arise most directly from forecasts implicit in any situation. Given a certain point in a map, the situation, as defined by the prior path, the subsequent paths are a forecast of the expected results. Thus by associating current or hypothesized conditions with map locations, forecasts are automatically generated.

Commercial applications arise from PM's analytic ability to partition the contributions to the probabilities of outcomes (to paths and events). These include defining the contributing factors to purchasing choices (and other measures of consumer behavior), defining contributions to sales by product features, and other areas where the question is: to what degree do various factors and combinations of factors contribute to the outcome.

Public policy applications arise from both predictive and analytic capabilities, and have much the same logic as commercial applications: either forecasting events or partitioning the degree of influence.

This invention features a computer-implemented method of modeling and analyzing disjunctive systems, especially systems containing human behaviors, comprising providing information relating to the behavior comprising a number of discrete variables each comprising at least two alternative states, creating from the information a model that defines paths comprising a series of steps from one variable state to another to one or more outcomes, assigning probabilities to the steps of the paths, storing the model, including the assigned probabilities, in an electronic database, and using a computer processor to determine the cumulative effect of the paths on the probability of outcomes.

The method may further comprise segmenting continuous variables to produce discrete variables for the model. The method may further comprise adding to the model the complement of one or more variables adding a variable state that does not reflect measured or identified quantities in the data. The database may be a relational database. The method may further comprise adding to the database additional records related to one or more variables.

Assigning probabilities may comprise determining how many times one variable state directly follows another variable state or sequence of variable states and dividing by the number of occurrences of the previous state or sequence. Assigning probabilities may further comprise determining the conditional probability of a variable based on the directly preceding variable states on a path, to model the effects of events in a particular sequence. The probability of a path may be the product of all of the probabilities along the path. The probability of an outcome may be the sum of the probabilities of all of the paths that lead to the outcome.

The method may further comprise querying the database to find paths that fulfill the requirements of a logical statement comprising two or more variables. The method may further comprise allowing selection of the variables for the database query. The method may further comprise identifying a particular outcome and in response identifying each path that leads to that outcome. The method may further comprise reporting the identified paths and one or more of the path's individual and cumulative and rank ordered contributions to the probability of the outcome. The report may comprise a graph.

The method may further comprise determining the likelihood of a path to produce the path's outcome and rank order those paths by likelihood. The method may further comprise determining the probability of an outcome given a particular variable state. The method may further comprise determining the overall gain or loss in outcome probability if a variable occurs compared to the previous variable. The method may further comprise determining the overall gain or loss in outcome probability if a variable state occurs compared to the variable state's complement. The method may further comprise determining the sum of the probabilities of the paths on which a particular variable lies. The method may further comprise determining the paths on which the complement of a particular variable state lies.

The method may further comprise determining the value, in monetary or other utilities of an outcome. The value may be determined by relating a monetary value with one or more variables. The method may further comprise providing a comprehensive description of the probability relationships in the data. The method may further comprise defining individual variables states by the context provided by the other variables states on the same path. The method may further comprise providing data for agent based simulations and other simulations and sensitivity tests.

### BRIEF DESCRIPTION OF THE DRAWINGS

Other objects, features and advantages will occur to those skilled in the art from the following description of the preferred embodiments and the accompanying drawings, in which:

FIG. 1 is an example of an output display that can be created by the invention, in this case a percentage graph of cumulative outcome probability; and

FIG. 2 is a detailed flow chart of the operation of the preferred embodiment of the invention.

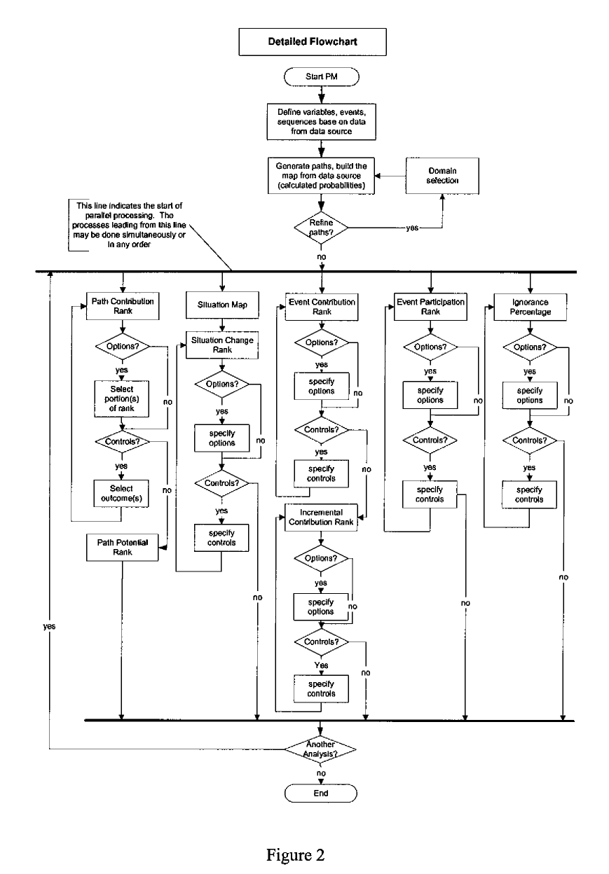

### DESCRIPTION OF THE PREFERRED EMBODIMENT

### Construction of the Database

A conventional flat cases by observations database is used for the basic model. It contains both categorical and continuous variables. Some specialized features, including calculating expected values, classification of variables, decision making modules, and supporting agent based simulations require a relational database.

The variables in the basic flat file are arranged to reflect their conditioning relationships. In general this would be in order of occurrence. Simultaneous variables and preexisting conditions need not be in any particular order with respect to each other.

Continuous variable, however, must be converted to categorical variables by assigning categories to segments of their range. These segments are added to the database as new categorical variables. A number of different segmentations are likely to be possible. For example, a scale of income might be divided into rich, middle income, and poor; or much less than me, less than me, the same as me, more than me, and much more than me; or adequate and inadequate; and so on, each with its own dividing lines. One segmentation does not preclude the other. In combination they give a fuller understanding of dimensions of the continuum. As many segmentations as appear informative can be included in the database. (There is automated support for devising and testing segmentations see Incremental Contribution/Segmentation Support below.) The categories that the segmentations produce, rather than the continuous measures from which they are defined, are used to construct the maps from the database. To allow revisions, the database retains both.

Although this is overview, a few words about what the database represents are appropriate, since PM provides opportunities for utilizing a more open and nuanced approach to data collection than is typically feasible.

Segmenting continuous variables allows assigning probabilities to events, so it is a technical necessity for constructing probability trees. But it also allows us to unpack continua into their various interpretations or dimensions, a substantive gain. Starting with George Miller's classic 1956 paper, The Magical Number Seven, Plus or Minus Two: Some Limits on Our Capacity for Processing Information, there have been a series of demonstrations that we break continua into a rather limited number of categories, and that there are cognitive limitations that force such strategies upon us. (The tendency to stereotype, to create dichotomies, to consider only a few options when making decisions, and so forth, seems to be more than just a bad habit.) Thus a model of human behavior that tracks how one thing leads to another, if it works from continua, is using a surrogate for the information that actually guides choices and other responses. What we are actually using is categorical interpretations imposed on ranges within continua.

It is also apparent, however, that people do not necessarily use the same categorizations, and that individuals may use different categorizations over time and across situations. Thus more than one segmentation is apt to be required for an accurate representation. In probability mapping there is no technical restraint on inclusion of variables to capture this multidimensionality (regardless of how highly correlated), and this multidimensionality imposes no obstacles to interpretation. There is no need to collapse the difference using an average or some other summary measure. The maps and the analytic tools are designed to deal with networks where outcomes occur in a variety of ways, some similar, some not.

There is a parallel in the handling of multidimensionality that applies to categorical variables as well. We make multiple interpretations of events as well as of segments of continua. A manager, for example, might give a report that some see as giving orders, others as recommendations, and others as a contribution to an open discussion of possible actions. And one person might see it in these different ways at different times, or recognize that all are plausible. Subsequent behaviors may depend on differing and sometimes conflicted interpretations. For example, a diplomatic note rejecting a proposal can be read as a provocation, an invitation to further discussion, a stall for time, and so on—and it is common for different people to make contrary interpretations. To the extent information is available, data representing these diverse interpretations would be included. Probability mapping never forces one to choose the representations thought most characteristic or likely over alternatives, or to amalgamate differing measures. If the representation (whether beginning as a segmentation or a categorical variable) proves uninformative it can be removed from the model during analysis.

In addition there are many phenomena, such as personalities or social organizations, which are multidimensional in nature, and are understood as a cluster of characteristics with somewhat loose membership. The Diagnostic Statistical Manual (DSM) of the American Psychological Association, the standard work for classifying mental disorders, works on this principle. This kind of representation is natural to PM. If a cluster of characteristics hangs together, and to what degree, or if they don't, will show in the analysis. The effectiveness of the model does not depend on it coming out one way or the other.

There is no in-principle limit on the numbers of dimensions, regardless of the similarities or lack of them, which may be used in a map. Also, a large number of dimensions does not create problems for interpretation due to the nature of PM's analytic tools (see Analytic Suite below).

Thus the database is well adapted to represent to the human world of multiple and shifting interpretations and dimensions, and less likely to force choices for the sake of model building. At the same time there is no requirement that the models be complete (to avoid specification error). Analysis can begin with a simple model, see how well it works (how much of the probability of the output can be accounted for with well defined paths), and build up from there if necessary. PM works with whatever is available.

It will sometimes be the case, whether beginning with categorical variables or having created categorical variables from continuous variables, that there are behaviors that are either unknown or which cannot be categorized in an informative manner. For example, we might know that it is common for people to interpret and misinterpret evolutionary theory in certain predictable ways which we can classify, but some defy classification. So there would be a none of the above or other category to act as a catch-all. Similarly, we might know most of the ways people react to bad news, but some people surprise us nevertheless. All we know in these cases is that some responses will not be ones we can anticipate. In data bases these are entries such as ‘NA,’ or ‘other,’ and so forth. These responses, the complement of what we can anticipate, are simply labeled NOT—they are NOT in our existing categories. Similarly, we may have a range in which we can only attach meaningful labels to some of the segments. This NOT label marks paths that are not well defined, a useful marker that shows the location of our ignorance. The sum of the probability paths containing NOTS provide measures of the degree of our ignorance.

### Values and Classifications

The database described above is a flat file. As mentioned above, if we want to include data on the cost or other quantitative valuation of events, records in the flat file would have additional records related to it. Similarly, if we want to record various ways events are classified or named, or other supplementary information, a relational database would be constructed.

### Building the Map from the Database

The PM's sequence is defined by the sequence in the database. Its probabilities are calculated by counting how many times an event follows other events, and dividing by the number of times those other events occurred. These other events are the event's conditions. Thus the process of building the map is a straightforward combination of following the sequence, counting, and dividing.

Consider a database with three observations of two variables, each containing two categories.

| Observation | Variable 1 | Variable 2 |
|---|---|---|
| 1 | A | C |
| 2 | B | C |
| 3 | A | D |

Since A occurs two out of three times, and B one out of three, their probabilities are 0.67 and 0.33 respectively. (Since this is the first event in the model it condition is the state of the world when that event occurs, which applies to all three.) So the first step in the model is,

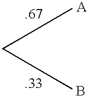

The second step in the model is conditioned by the first, that is, the probabilities of Variable 2 are calculated with respect to what has occurred previously. Since C occurs half the time that A occurs, and D the other half, their conditional probability, P(C|A) and P(D|A) are 0.5, so we have:

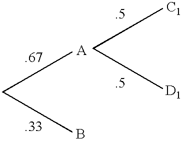

The final branch is added the same way, as could any number of further branches, for a tree of any dimensions. (The tree below includes path probabilities that are discussed immediately below.)

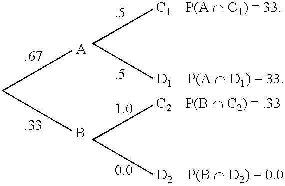

The probability of each of the four paths is the product of the probabilities along it, which is shown at the end of each path. For example, the probability of getting to C₁ via A, the probability that both A and C will occur, is,
P(A∩C₁)=0.67×0.5=0.33

The tree is a map of how to get to C or D, its outcomes, from preceding events A or B—a map describing sequences of events linked by conditional probabilities instead of locations linked by routes. The probability of C is the sum of the probabilities of the two paths leading to C, and the probability of D is the sum of the probabilities of the two paths leading to D.
P(C)=ΣP(C_{i's})=0.33+0.33=0.67
P(D)=ΣP(D_{1's})=0.33+0.0=0.33

The sum of the probabilities of all paths is always 1.0.

### Analytic Suite

In practice, even simple PM's will be too large to interpret by inspection. A fairly small map, for example, ten variables with each variable containing four categories, contains 4¹⁰, or 1,048,576 paths. If we tried to print it on standard size paper we would have a black smudge of microscopic lines and numbers. If we enlarged it enough to make out the paths and numbers, we would get lost in the details and the multitude of computations required. Instead, the map is treated as a database which includes a network of relationships and their probabilities. It is not a description to be interpreted by direct inspection. We make sense of it with tools that bring out the network's salient features and measure their effects.

For practical questions the Situation Map and the Situation Change Rank are the key measures. They give direct answers to the questions: what is likely to happen and what can we do about it?

For general understandings, Path Contribution, Path Potential, Event Contribution and Incremental Event Contribution, are the most informative. Path Contribution shows how much each path contributes to the probability of the outcome. Path Potential shows the power of a path to produce an outcome, if the path occurs. Event Contribution shows how much events contribute to the paths they are on. Incremental Event Contribution compares the effect on an outcome of the presence or absence of an event. (Incremental Event Contribution is the basic tool for testing segmentations. If the segments' incremental contribution approaches zero, the segment contains little useful information.)

Event Participation is a measure of how likely we are to see an event than its effect on an outcome. Where there is high Event Participation but low Event Contribution, Event Participation is, in effect, a measure of spurious correlation.

Ignorance Percentage is a measure how much of the probability of the outcome is derived from unspecified events.

Terminology

Each variable, in the language of probability theory is a ‘sample space’ or ‘universe.’ It contains a set of ‘possibilities’ ‘events,’ or ‘states,’ one of which will occur (if none occur which fit the defined categories it is the complement of the variable, labeled with a caret.) These events are the (categorical) values or states of the variable, and they are alternatives to each other. We will use all three terms to refer to these values, which ever works better in context.

The analysis of variance usage of accounted for is adopted herein when discussing probabilities. To say, for example, that a percentage of an outcome is accounted for by a path means that that portion of the probability of an outcome occurred in the ways that path describes.

An Example

The example PM is constructed from four variables, ‘A’ through ‘D.’ Each variable has two states, either labeled by numbers, or by a preceding caret symbolizing a logical ‘not.’ State ‘D1’ of variable ‘D’ will be considered the outcome for the purposes of the example. The numbers in bold face below the state labels indicate the probability of the outcome given that location. Thus in this example there are four paths that account for the great majority of the outcome's probability (0.57 of 0.66 total, or 87% of the outcome of ‘State D1’).

This example model, unlike models of most real human situations, is small enough to understand by inspection.

Probability Map

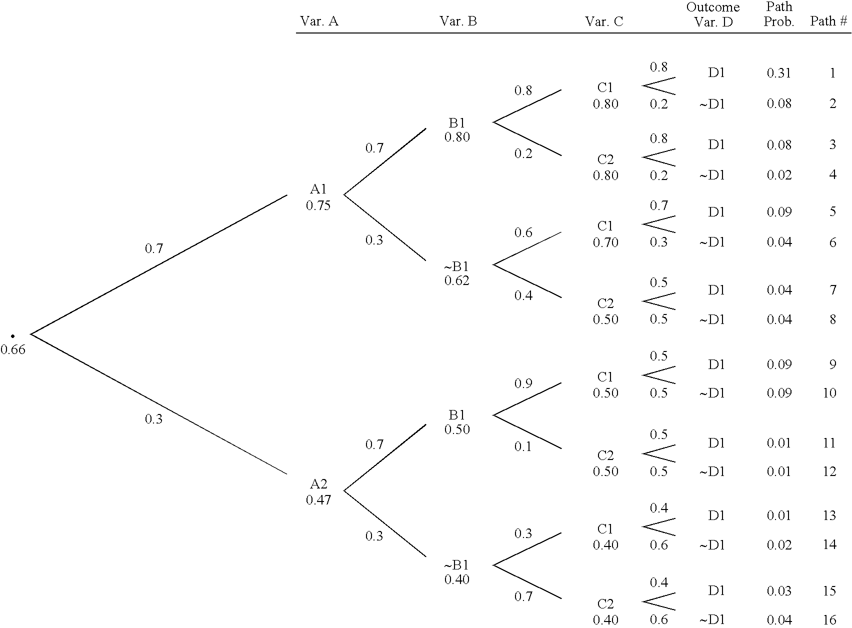

Note that variable states (events) can be interpreted locally, in the context of the other events on the same path. A consistent interpretation across path is not required to understand individual paths, or for path-based measures—which are the key measures in Probability Mapping. Within path interpretation allows a more nuanced definition of terms than conventional models, which rely on a single definition throughout. Also, it parallels the everyday use of context to define terms. This makes the model more accessible, not only by the familiarity of the method of interpretation, but by lessening the reliance on formal and abstract definitions.

### Domain Selection

Domain Select: This tool controls the domain of an analysis. It allows selecting any set of path that fulfills the requirements of a logical statement defining a path's contents. The statement can reference variables, variable states, probabilities associated with variable states, user supplied path names, and classifications if the module is included.

### EXAMPLES

Path 4 could be selected by: Paths=Var. A: State A1, AND Var. B: State B1, AND Var. C: State C2, AND Var D State D1.
A conditional statement may be constructed to select all path containing D2 where the probability of D2 greater than or equal to 0.04. PATH=D2<=0.04. This would select paths 4. 6. 8. 12. 14, and 16.
A single variable state (event) can be selected: STATE C2 following A2 AND B2: STATE=A2, B2, C2. (Or State C2 FOLLOWING A2 AND B2.
Interface: Variable list pull down or scrolling menu, logical operator buttons, and numeric value setting arrows for point and click operation. The statement appears in a command line that can also be typed in directly. A custom naming capability is available to assign names to record domain definitions. The custom naming capability creates scrolling or pull-down menus to aid analysis that requires shifting domains or requires exploring changes in domain specification without losing an initial definition.
The standard set of logical operators (AND, OR, NOT, LESS THAN, MORE THAN, etc.) are available.
There are three special operators, ‘PRIOR PATH,’ ‘SUBSEQUENT TREE,’ and ‘SITUATION MAP,’ which center on an event and show its antecedents, consequents, or both. See Situation Map below for details.
There are two special operators ‘FOLLOWING,’ and ‘PRECEDING,’ to simply identifying locations on a path.
There is a special operator, ‘OUTCOME,’ defined by a logical statement. An outcome can include any number of variables along a path, so an outcome can, for example, be defined as a final state and various conditions that lead to it. Since it may include logical OR's, an outcome can include more than one state of the world. An outcome excludes all variables to its right, if any, from the model.
Domain Selection can also be performed using the output of the analytic tools discussed below.

### Path Contribution

Path Contribution Rank: Rank orders the paths by contribution to the probability of an outcome, with measures of the path's individual and cumulative contributions. This is the basic tool for partitioning the effects of paths, and overall, how many paths are crucial to producing the outcome.

Path Contribution Rank for Outcome D1

| Path | P(D1) | Cum | % D1 | Cum % |
|---|---|---|---|---|
| 1 | 0.31 | 0.31 | 0.47 | 0.47 |
| 9 | 0.09 | 0.41 | 0.14 | 0.62 |
| 5 | 0.09 | 0.50 | 0.13 | 0.75 |
| 3 | 0.08 | 0.57 | 0.12 | 0.87 |
| 7 | 0.04 | 0.62 | 0.06 | 0.93 |
| 15 | 0.03 | 0.64 | 0.04 | 0.97 |
| 13 | 0.01 | 0.65 | 0.02 | 0.98 |
| 11 | 0.01 | 0.66 | 0.02 | 1.00 |

Note that in this example that nearly 90% of the outcome's probability can be accounted for by the top four paths.

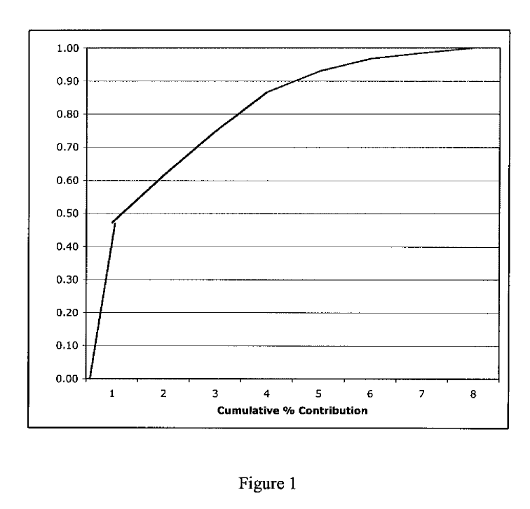

Graphical Displays: 1) Cumulative Percentage Contribution Graph (FIG. 1). In this graph Y=cumulative output probability accounted for, X=number of paths in rank order. In the example, as just noted, a relatively small number of paths account for most of the probability, so the line rises quickly at first then rises more gently thereafter. 2) Path Contribution Graph (histogram): Y=% of output probability accounted for, X=number of paths in rank order. 3) Map of paths accounting for X percentage of the outcome probability (shown below, only applicable when the number of paths is small enough to make inspection feasible).

Probability Map: Four Paths Accounting for 87% of D1

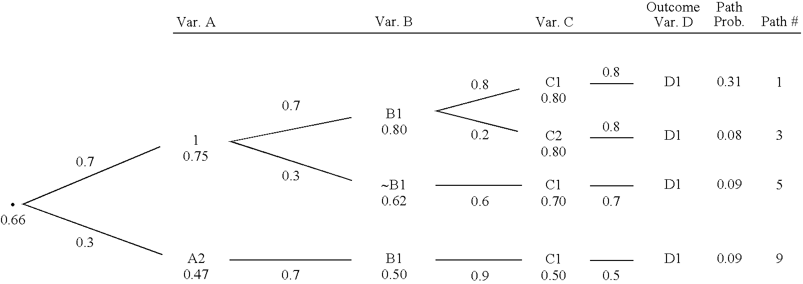

Options: 1) Select any portion, or portions, of the rank for analysis. For example, select paths by an outcome and deselect paths that fall below a threshold of individual contribution to the probability of an outcome, or to the right of the inflection point where the path contribution slope flattens in the Cumulative Path Contribution Graph. Delete this selection from the domain. This can remove paths that don't make enough of a difference to make a difference, at least for the question at hand, and can greatly reduce the size of the map. 2) Display path to path differences.
Controls: Select by outcome or outcomes. Select by outcome probability. Select by pointing at a position in a graphical display. Remove from Domain

Path Potential Rank: Measures the conditioning effect of the path on the outcome regardless of the path's probability. P(Outcome|Path). This is a measure of a path's ability to produce the outcome but not whether it is likely to actually do so. It is, a measure of the strength of the relationship between a path and an outcome, but not of the outcome probability that path accounts for. It would, for example, give a high rank to a path that was in itself highly improbable but leads to a highly probable outcome—and vice versa.

Path Potential Rank

| Path | P(D1\|Path) |
|---|---|
| 1 | 0.8 |
| 3 | 0.8 |
| 5 | 0.7 |
| 15 | 0.6 |
| 7 | 0.5 |
| 9 | 0.5 |
| 11 | 0.5 |
| 13 | 0.4 |

### Event (Situation) Contribution

Event Contribution measures the probability of the outcome, given the event: P(D1|Xₙ) For any event (a single node in the model) there is a probability that the outcome will subsequently occur. That probability is the sum of the probabilities of the paths leading to the outcome in the tree that forms to that event's right—what we will call the subsequent tree. (It also may be calculated as the sum of the probabilities of the outcome of that tree, divided by the sum of the probability of all outcomes of that tree.) These Event Contribution probabilities are the bold numbers on the map.

The event contribution on a path is the PM's descriptions of a situation. Examining the prior path shows what led to that position, and examining the subsequent paths shows what might happen.

Event Contribution is a measure of the value of an event for obtaining an outcome, and may be used for comparisons across events or contexts (on different paths). There is a gain, for example, in going from ˜B1|A1 to C1, but not from ˜B1|A2 to C1. (See Incremental Contribution Rank, Situation Map, and Situation Change Rank below).

Event Contribution Rank: A broader measure of event contribution, an average of individual contributions weighted by their probability as shown in the table. It applies to the entire map, but optionally can be applied to selected events using domain select.

The table below applies to the entire map.

Event Contribution Rank

| | | |
|---|---|---|
| Event | Overall Con. | Range |

| | | | |
|---|---|---|---|
| 1 | 0.75 | 0.75 | 0.75 |
| B1 | 0.71 | 0.80 | 0.40 |
| C1 | 0.68 | 0.80 | 0.40 |
| C2 | 0.64 | 0.80 | 0.40 |
| ˜B1 | 0.55 | 0.62 | 0.40 |
| A2 | 0.47 | 0.47 | 0.47 |

Incremental Contribution/Segmentation Support

Incremental Contribution Rank: Measures the overall gain or loss in outcome probability if an event happens compared to the previous state. For example, for variable B1 the incremental contribution would be the gain or loss in outcome probability compared to variable A1 or A2. For practical purposes this is a telling measure. It answers, at a more general level than the Situation Change Increment, the question of do you want this event to occur to by measuring how much the situation improves or deteriorates. And it allow comparing, by gain or loss, any set of states.

The difference measure, X−˜X, measures the expected gain or loss if the event rather than its complement occurs. (Ranking may be by Expected Gain or Difference at the user's option.)

Incremental Contribution Rank

| Event | Ex. Gain | X − ˜X |
|---|---|---|
| 1 | 0.09 | 0.28 |
| B1 | 0.05 | 0.16 |
| C1 | 0.01 | 0.05 |
| C2 | −0.04 | −0.05 |
| ˜B1 | −0.11 | −0.16 |
| A2 | −0.19 | −0.28 |

Where there is more than one alternate, by default it treats the others as a single possibility—the complement—whose outcome probability is a weighted sum. The weights are the probabilities of each alternative given that selected alternative does not occur—in effect creating an average of the other alternative's outcome probabilities.

The weight for each alternative is (where A's are outcome probabilities),

$$\frac{P ( {A}_{1} )}{P ( {A}_{1} ) + ( {A}_{2} ) + ( {A}_{3} ) + … + ( {A}_{n} )}$$

Segmentation Support: A correctly segmented variable will show different effects on the outcome for each event compared to any other event for a selected range of paths (including the whole map). If the events are two segments, the Incremental Contribution Difference Measure would be,
P(X|Segment 1)−P(51 Segment 2)

Automated segmentation support tools will test various segmentations, beginning with user input or with a default value (such as, with respect to Miller, seven even divisions), seeking to maximize the differences between the contributions of segments. Contiguous segments showings differences that approach zero or are otherwise judged too small to make a substantive difference will be collapsed (criteria are entered by the user or set to defaults) into a single segment. As a second stage, the new lines dividing segments can be moved to maximize differences.

Each remaining segment then becomes an event in the map.

The user may label the segments, which function as variable states by substantive interpretations (such labeling segments of a variable ‘income’ as ‘poor,’ ‘middle class,’ ‘wealthy’).

Situation Map & Situation Change Rank: Describes the situation for any location on a path, and ranks the alternatives that may be available. The map below shows the situation for event ˜B1 on paths 5 through 8.

Situation Map

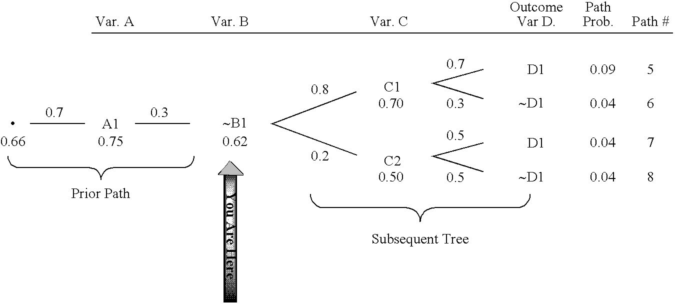

This map shows that two events have occurred (A1 and ˜B1), and from the resulting position (marked by the arrow) the probability of the outcome is 0.62. However, it may be possible to improve the situation, that is, to change the probabilities of subsequent events, by changing the current situation.

The Situational Change Rank shows the effect of changing the prior path, in effect, moving from one path to another. It lists the potential changes in order of making the smallest changes first (one event difference) and within the groups from least change to greatest, in order of their contribution. In this simple example, there are only three potential changes. (Prior paths are identified by the range of subsequent paths they lead to.)

Situation Change Rank

| # Changes | Prior Path | Contribution | Increment |
|---|---|---|---|
| 0 | 5 thru 8 | 0.62 | 0 |
| 1 | 1 thru 4 | 0.8 | 0.18 |
| | 12 thru 15 | 0.4 | −0.22 |
| 2 | 9 thru 12 | 0.5 | −0.12 |

In this example the Situational Change Rank offers only one positive alternative, which requires changing only one event. If this change is possible, replacing ˜B1 with B1, the effect would be to move from the path 5 thru 8 to path 1 thru 4 and a gain in outcome probability of 0.18.

This simple PM used in this example does not give any information about what it would take to make this change, especially since A and B are independent. A more realistic example would be likely to contain dependencies that a decision maker, using the Situational Change Rank, would be considering changing. Using the event or events under consideration for change as outcomes, the prior portions of the map can be analyzed using the tools in the analytic suite, just as if it were any other outcome. Thus we would look to see under what conditions these changes were most likely, which would allow intelligent consideration, given time and resource constraints, of what choices would be most useful.

Any data analysis can only go as far as what the data shows, so if we introduce a path which has not been observed, such as a path which goes from ˜B1 to B1, we may be generalizing beyond what the data can support. This is a problem inherent in making choices based on understandings derived from experience—a problem facing data analysis in general not specifically a problem of PM. But in PM, where a wealth of alternatives paths is part of the model, we have a large database to examine containing the conditioning effects of numerous combinations of variable states, including unusual ones. This allows bringing a great deal of information to the process of deciding what the consequences of untried paths might be, not only might there be examples of similar prior paths there also might be situations, such as delays, that suggest what effects might be expected even though the paths are dissimilar.

In a stable environment changes are represented by alterations in path probabilities rather than changing the content (sequence of events) of the paths, so an existing map can be used to investigate the effects of those changes (using a module to alter probabilities).
Graphical Displays: Situation Maps along the lines shown above
Options: Apply Situation Change mechanism using other measures, such as Path Potential, Incremental Contribution, etc as criteria. Calculate Expected Values (see Modules below) and use those the rank contribution measures;
Controls: Specify a minimum probability for the desired outcome or outcomes, a maximum probability for undesired outcome or outcomes, and a maximum number of changes. Specify event states that can or cannot be changed (see Modules for classifying variables)

### Event Participation

Events along a path, unlike the paths themselves, are not independent contributors to an outcome. They are parts of paths and make their contribution as such: by their conditioning effects, whether directly on the outcome or on other events which, in turn, directly or indirectly condition the outcome. As paths are to outcome, events are to paths.

The utility of event based measures depends on their having consistent meanings across paths, at least with respect to the issues at hand. While this is not required for path based measures, it is generally required in conventional data analysis, so we are used to working within this requirement.

Event Participation Rank: Events are ranked by the sum of the probabilities of the paths they are on.

Event Partipation Rank

| Event | Path Prob. | # Paths |
|---|---|---|
| 1 | 0.52 | 8 |
| C1 | 0.51 | 8 |
| B1 | 0.50 | 8 |
| ˜B1 | 0.17 | 8 |
| C2 | 0.16 | 8 |
| A2 | 0.14 | 8 |

(Note: the number of paths measure is not informative when applied to the full map, since all the numbers will be the same. It would be informative in analyses where a subset of the paths is selected for investigation. See below.)

Participation does not mean contribution or influence. It simply indicates presence. Thus when D1 occurs we would see the higher ranked events most often, with the probabilities indicated. In this, it is a useful pointer, not only to what we should expect to see, but when measures of participation and contribution are far apart, to how appearances mislead. An example is comparison with the incremental contribution of C1.

Options: Event Participation for selected paths (the table below selects the four paths accounting for 87% of D1's probability.)

Selected Path Event Partipation Rank

| Event | Path Prob. | # Paths |
|---|---|---|
| 1 | 0.48 | 3 |
| C1 | 0.50 | 3 |
| B1 | 0.49 | 3 |
| ˜B1 | 0.09 | 1 |
| C2 | 0.08 | 1 |
| A2 | 0.09 | 1 |

We can also rank the participation of combinations of the predominant events, which have nearly equal participation.

Selected Combinations Participation Rank

| Combinations | Path Prob. | # Paths |
|---|---|---|
| A1 & B1 | 0.39 | 2 |
| A1 & C1 | 0.40 | 2 |
| B1 & C1 | 0.41 | 2 |

Output Distribution: Simply a discrete distribution of any defined output.
Graphical Displays: A histogram of the distribution. In the case of the example with only two outcomes, D1 & ˜D1 there would only be two bars, a more realistic number of outputs would produce larger distributions. In the case of example with value measures, each bar would represent the probability of a range of expected values.

Ignorance Percentage: Measures the percentage of paths containing a complement rather than a defined variable. (In the example, ˜B is a complement, whereas B2 would have been a defined variable.

Complements are whatever happens if an event doesn't happen, and, at least in the database, have no further definition. In short, all we know about them is what they are not. Thus we are ignorant of what they represent, and a path containing at least one such element is, in effect, a black box. We know its conditions and its conditioning effects, and we know what it is not. But we do not know what it is. If these paths are important, the ignorance measure points to what we don't understand but probably should. It also suggests a weakness in our ability to decide if it is reasonable to expect to generalize the map's findings.

Probability Unaccounted for (P. UnAcc) in the Ignorance Percentage Table indicates the sum of the probabilities of the paths containing complements.

Ignorance Percentage

| # Paths | % Paths | P. UnAcc. |
|---|---|---|
| 8 | 50 | 0.34 |

### Modules

### Classifying Variables (Relational Database)

It will often be the case that we are interested in particular sets of variables because they are subject to manipulation, or have significant economic, organizational, or moral implications. Thus we would want to make inquiries of the model, using the Situation Change Rank, for example, restricted to, or away from, those variables. Relational data entries which classify variables and/or variable states (events) allow this capability.

### Measuring Economic Outcomes (Relational Database)

If it is appropriate to attach monetary or other measures of value to various outcomes, we can add estimates of the expected value of each possibility shown by a situation map. For example, if in the situation map shown above D1 is worth 25,000 dollars and ˜D1 is a loss of 10,000 dollars, the expected value of being at ˜B1 is,
E(˜B1)=(0.62×25,000)+(0.38×−10,000)=15,500+−3800=$11,700

This is a simple but powerful expansion of Probability Mapping's capabilities. It gives the value, in dollars, for any choice on the map. For instance, the value of C1 compared to C2 is,
E(C1)=(0.7×25,000)+(0.3×−10,000)=17,500+−3000=$14,500
E(C2)=(0.5×25,000)+(0.5×−10,000)=13,500+−1500=$12,000

Thus the expected value of C1 over C2, in dollars, is
14,500−12,000=$2500

This gives us the capability to compare the value of any choice, as it ramifies through the network. We might, just to give a range of examples, be considering alternate contract provisions, different locations to locate a new retail outlet, or job candidates with differing qualifications competing for the same job. As long as the database covers the appropriate comparisons the expected value can be generated.

We can also use cost information as the ranking criteria for the Situation Change Rank.

### Decision Making (Relational Database)

Choices based on a Situation Change Rank can be made be comparing expected values rather than outcome probabilities. This may require optimization routines when faced with multiple and mutually exclusive tradeoffs and constraints, but can be handled with conventional techniques. Decision making modules can be developed for stock portfolio choices, marketing options, and other strategic choices facing disjunctive and uncertain systems.

### Trend Tracking

Track on-going shifts in probabilities over time. Allows a dynamic model, and testing for the stability of path probabilities.

### Operational Support and Alerts

Once a map has been created it can be used for operational forecasts. As situations change different prior paths define the current situation, and these correspond to different subsequent paths, producing a new forecast.

This module allows PM to be used for operational decisions, such as in real estate pricing or putting together tour packages, with only periodic reanalyzes to insure that the Map is still valid. Prior to using the Map for operational support, trend tracking should be instituted to insure stable path probabilities.

Alerts can be set when a shift in the current situations produces forecasts that indicate problems or opportunities

### Templates (Relational Database)

Templates identify particular subsets and measures that have proven useful, avoiding having to enter logical strings defining subsets for repeated analyses The templates allow combining domain selection logical operators, a sequence of analyses, and the classification module.

### Sensitivity Analysis and Agent Based Simulation (Relational Database)

The map is treated as a description of a system, not a sample (We are not estimating population parameters; we are describing the probability relationships in the data.). As such we may question how well a finding will generalize.

That is, if the conditional probabilities vary from those observed, how robust are its findings? There are already measures indicating the variables to which sensitivity should be expected, the Incremental Contribution Rank in particular. However, if we wish to systematically explore the quantitative effects of varying the probabilities around the observed values, that capability is provided by this module using conventional methods of assigning probability distributions to events and running the model multiple times using random probabilities from those distributions.

A simpler use of this module is updating probabilities that are known to have changed.

The probabilities calculated for the map can also be applied outside the map itself. Agent based simulations are built on modeling the behavior of individual agents (such as customers or voters) whose propensities are defined by a series of conditional probabilities. These probabilities can be provided by the database calculations and exported to a simulation module.

### Data Analysis Comparison

PM is designed to efficiently provide information for the purposes of making practical decisions and plans. The key tools are the Situation Map and the Situation Change Rank. As we have seen, they show the probability distribution of events that follows from any event on a path, and the allow identifying paths that inform us about the consequences of taking actions to change that situation. In short, what to expect, and how to change those expectations. In addition, because these tools operate at the level of specific behaviors, rather than aggregations and other summaries, they operate on the level of specificity that real decisions require. The other tools both provide a broader view, and help in making related inquiries.

The question the comparison asks, then, is what it would take to get this information using conventional statistics, and whether, using those methods, we are likely to be asking the right questions. We will use a regression analysis (including correlations), the most commonly used statistic tools for trying to understand multivariate relationships with a single dependent variable, for comparison.

### Correlation and Regression Analyses

A correlation matrix provides an overview of the pairwise relationships of variables. Since correlation is a measure of linear relationship, and linear relationships between dichotomous variables are impossible except when the correlations is 1.0, the values of the correlations will generally understate the strength of association between discrete variables. This does not make correlation an inappropriate measure, only one which cannot be interpreted by the same variance accounted for standards as when linear relationships are available.

Correlation Matrix

| | A | B | C | D |
|---|---|---|---|---|
| A | 1 | | | |
| B | 0.03 | 1.00 | | |
| C | 0.04 | 0.32 | 1.00 | |
| D | 0.27 | 0.16 | 0.09 | 1.00 |

In the matrix A1 has the strongest relationship with the outcome, D1, followed, with a considerable drop in each instance, by B1 and C1. Looking at relationships between variables, we see little connection between A and B or A and C. The connection between B and C, however, is the strongest in the matrix. Since there are no negative correlations, A2, ˜B1, and C2 are not referenced. This is not to say that A2, ˜B1, and C2 never co-occur with D1, but that on average D1 is more likely when A1, B1, and C1 occur then when A2, ˜B1, and C2 occur. This disinterest in less likely connections reflects the differences in orientation between PM, which is interested in specific way one thing leads to another, and correlation/regression, which is interested in characterizing an overall relationship

In terms of probabilities, correlations can be thought of as measures of independence, in a statistical sense. A and B are independent if P(A|B)=P(A|B) and P(BA)=P(B|˜A). A low correlation, for example, indicates that variables are independent or nearly so. In this matrix, A and B, and A and C, appear independent, or nearly so. (Significance tests might be used to decide if the small relationship should be treated as more than accidental.)

Although correlations do not measure probabilities (see below), simple regressions on the same variable pairs do. The regressions produce only two predicted values. They are the probability of the variable state coded 1 in the dependent variable when the variable coded 1 in the independent variable occurs, and the probability of the variable state coded 0 in the dependent variable when the variable coded 0 in the independent variable occurs. These are (estimates of) the same probabilities as the Overall Event Contribution probabilities calculated in the PM. (These same probabilities can also be obtained from contingency tables when set to display percentages.)

For example, a statistical package's output for a regression using A to predict D would produce the following table (or something very much like it):

Regression Predicting D as a Function of A

| | |
|---|---|
| Rsquared = 7.1% | Rsquared (adjusted) = 6.2% |

s = 0.4611 with 100 − 2 = 98 degree of freedom

| Source | Sum of Squares | df | Mean Square | F Ratio |
|---|---|---|---|---|
| Regression | 1.6019 | 1 | 1.6019 | 7.53 |
| Residual | 20.8381 | 98 | 0.212634 | |

| Variable | Coefficient | s.e. of Coeff | t-ratio | prob. |
|---|---|---|---|---|
| Constant | 0.466667 | 0.0842 | 5.54 | ≦0.0001 |
| A | 0.27619 | 0.1006 | 2.74 | 0.0072 |

The coefficients from that table can be plugged into a prediction equation whose general form is, (where b₀ is the constant, b₁ is the constant's coefficient, and the xₙ's are the values of the constant (1) and variables.)

y=b₀x₀+b₁x₁

This works out, when A has a value of 1 to,
P(D1|A1)=0.467×1+0.276×1=0.743

And when A has a value of 0, to
P(˜D1|A1)=0.467×1+0.276×0=0.466

These are a very close estimate of the values we find in the Overall Event Contribution table for A1 (0.75) and A2 (0.47). (The correlations themselves are not good measures of probability. While the correlations of A, B, and C with D, while in the right rank order of the probabilities of the same relationships, they do not suggest the absolute or relative magnitudes of the relationships.)

The other probabilities predicted by simple regressions are generally close to the event contribution numbers.
P(D1|B1)=0.71
P(D1|˜B1)=0.55
P(D1|C1)=0.68
P(D1|C2)=0.59

Only the value of D1|C2 is off, the actual probability is 0.64

Looking at the regression table below. R square is a measure of the percentage of the variance of the predicted variable explained by the linear relationship between the variables (it is the square of the multiple correlation). As noted earlier, since these relationships are not linear, it understates the strength of relationship. Since, in this example we are examining relationships in a made-up data set and are not concerned with generalizing to a population, the other measures shown in the table, the F and t ratios, and the associated significance tests are not relevant.

We can also estimate path contribution numbers using correlation/regression, although we are not likely to interpret them in the same way as in PM. Using multiple regression we can predict D1 as a linear function all three variables, although we cannot expect as accurate estimates since the coefficients attempts to capture the effects of different combinations. The resulting equation would generally be used make predictions and to understand the relationships among predictors with the respect to the outcome variable. The multiple regression coefficients are interpreted as measures of the unique relationship between each predictor and the outcome, that is, their relationship once the effects of the other predictors are removed. (Since, however, the correlations between the variables, except B and C, are small, there isn't much to remove.) They estimate the change in the dependent variable (the outcome) given the change in any independent variable, assuming all other variables are held constant.

(In practice, predictors that make marginal or statistically insignificant contributions to predicting the outcome are often removed from the equation. We will discuss the marginal contribution of C although it will stay in the equation. Since we are not treating this data as a sample, the issue of statistical significance does not arise.)

Regression Predicting D as a Function of A, B, & C

| | |
|---|---|
| Rsquared = 9.4% | Rsquared (adjusted) = 6.6% |

s = 0.4601 with 100 − 4 = 96 degree of freedom

| Source | Sum of Squares | df | Mean Square | F Ratio |
|---|---|---|---|---|
| Regression | 2.11927 | 3 | 0.706423 | 3.34 |
| Residual | 20.8381 | 98 | 0.211674 | |

| Variable | Coefficient | s.e. of Coeff | t-ratio | prob. |
|---|---|---|---|---|
| Constant | 0.34985 | 0.12 | 2.91 | 0.0045 |
| A | 0.270056 | 0.1005 | 2.69 | 0.0085 |
| B | 0.143034 | 0.1051 | 1.36 | 0.1768 |
| C | 0.031894 | 0.1096 | 0.291 | 0.7716 |

The coefficients from that table can be plugged into a prediction equation whose general form is, (where a is the constant, b is the coefficient of A, and x is the value of A.)

y=b₀x₀+b₁x₁+b₂x₂+b₃x₃

Since there are now three predictors instead of one, there are 2³ instead of 2¹ predicted values. These eight values represent the outcome probability for each combination of variable states for the three predictors.

This works out, for example, if A, B, and C have a value of 1, to,
D1=0.349×1+0.27×1+0.143×1+0.032×1=0.794

This is close to the contribution of C1 on path 1 and 2, which is when A and B have occurred (only path 1 goes to D1)—that is, the contribution of all three variables occurring. The other predicted values tend toward the low side but are still reasonable estimates of contribution. (The drop in accuracy from a simple regression reflects the regression model's use of a single coefficient for each variable, regardless of what other variables are ‘switched on.
˜D1=0.467×1+0.276×0=0.466

The predicted value table below shows the values for all eight combinations. To obtain the predicted values of D2 from this regression, simply subtract P(D1) from 1. For example, the predicted value of D2 for the combination of events, A1B1C1, is 1−0.8=0.2

Predicted Values: Regression of A, B, C, on D

| Events | P(D1) Predicted | P(D1) Actual | Cases | P(D1) × cases/100 |
|---|---|---|---|---|
| A1B1C1 | 0.79 | 0.8 | 39 | 0.31 |
| A1B1C2 | 0.76 | 0.8 | 10 | 0.08 |
| A1˜B1C1 | 0.65 | 0.7 | 13 | 0.08 |
| A1˜B1C2 | 0.62 | 0.5 | 8 | 0.05 |
| A2B1C1 | 0.52 | 0.5 | 18 | 0.09 |
| A2B1C2 | 0.49 | 0.5 | 2 | 0.01 |
| A2˜B1C1 | 0.38 | 0.4 | 3 | 0.01 |
| A2˜B1C2 | 0.35 | 0.4 | 7 | 0.02 |

Note that if you sum P(D1) · cases/100, you get the overall contribution of the tree, 0.66

By selecting subsets of the data, we can also obtain the contributions for any point along a path. For example, we can estimate the situation shown by the Situation Map, by estimating the probability of D1 given that A and ˜B have occurred.

| Dependent variable is: | D |
|---|---|
| cases selected according to | Aand˜B |
| 100 total cases of which 79 are missing | |
| R squared = 3.7% | R squared (adjusted) = −1.4% |

s = 0.5010 with 21 − 2 = 19 degrees of freedom

| Source | Sum of Squares | df | Mean Square | F-ratio |
|---|---|---|---|---|
| Regression | 0.183150 | 1 | 0.183150 | 0.730 |
| Residual | 4.76923 | 19 | 0.251012 | |

| Variable | Coefficient | s.e. of Coeff | t-ratio | prob |
|---|---|---|---|---|
| Constant | 0.500000 | 0.1771 | 2.82 | 0.0109 |
| C | 0.192308 | 0.2251 | 0.854 | 0.4036 |

Note that estimates of the probabilities of the path branches are also available from the frequency counts.

| | |
|---|---|
| Frequency breakdown of | predicted |
| cases selected according to | Aand˜B |

100 total cases of which 79 are missing

| | |
|---|---|
| Total Cases | 21 |
| Number of Categories | 2 |

| Group | Count | % |
|---|---|---|
| 0.50000000 | 8 | 38.095 |
| 0.69230769 | 13 | 61.905 |

We have seen, this far, that regression with dichotomous variables can be used to estimate event and path contribution numbers. In this example the correlation/regression work load is manageable. Eight regressions define the path contribution numbers, three define the event contributions, and six more cover the contribution numbers for situations—points on the paths. (The situation for A is already covered by its event contribution number.) If we had an example with 10 variables, there would be 1024 paths, requiring 512 regressions for the path contribution numbers, 10 regressions for the event contribution numbers, and 1022 for situation contribution numbers. A total of 1544 regressions, each giving two or more contribution numbers. In addition there would be frequency counts as required. Having done all this, information about the sequence of events would still have to be supplied ad hoc before the map, with somewhat less accurate probabilities, could be more or less recreated.

In practice, however, analyses based on correlation and regression are apt to follow an easier and less informative path. Analyses are usually aimed a finding a parsimonious model of the relationships between predicting and predicted variables.

Correlation/regression offers a route to finding parsimonious models from data. The correlation matrix shows that A and B are associated with D, but that C has little connection. In addition, A and B are independent of each other while C is correlated with B. Thus our expectation would be that the regression model would show A predicting D about as well as the correlation matrix indicates, but that B and C's predictive contributions would each diminish, given their covariation with D. And this is what we have seen in the regression.

We would not, however, be likely to keep all three variables in the model. C, with a coefficient of 0.03, has a negligible effect on the squared multiple correlation. R square stays at 9.4% whether or not C is in the model. Thus C would be removed. If this were a sample, the high probability (0.77) that the apparent connection is the result of sampling error would also lead to dropping C from the equation. The result, in either case, is a more parsimonious model with little if any loss in predictive power,

| | |
|---|---|
| Dependent variable is: | D |
| No Selector | |
| R squared = 9.4% | R squared (adjusted) = 7.5% |

s = 0.4579 with 100 − 3 = 97 degrees of freedom

| Source | Sum of Squares | df | Mean Square | F-ratio |
|---|---|---|---|---|
| Regression | 2.10133 | 2 | 1.05067 | 5.01 |
| Residual | 20.3387 | 97 | 0.209677 | |

| Variable | Coefficient | s.e. of Coeff | t-ratio | prob |
|---|---|---|---|---|
| Constant | 0.364743 | 0.1065 | 3.42 | 0.0009 |
| A | 0.271094 | 0.1000 | 2.71 | 0.0079 |
| B | 0.152886 | 0.0991 | 1.54 | 0.1260 |

Given this model and the correlation matrix, we would be likely to say that A1 and B1 lead to D1 (not a statement of cause but of observed association), that A is about twice as strongly associated as B, and that A and B act largely independently. Their combined effect, with an R² of 9.4% is greater that A alone, whose R² is 7.1%, and substantially greater than B alone, whose R² is about 2.5%. (R² measures the percentage of variation accounted for by relationships among variables, making for more interpretable comparisons. As noted earlier, the low numbers do not reflect the actual degree of association since R² is a measure of linear association.)

Looking at the predicted probabilities gives different and more tangible measures of association. B1, as the coefficients indicate, contributes more than half as much as A1, and the increase in probability of 0.15 when combined with A1 is substantial.

Probabilities: D given A&B

| Variables | Probability |
|---|---|
| A2, ˜B | 0.365 |
| A2, B1 | 0.518 |
| A1˜B | 0.636 |
| A1, B1 | 0.789 |

If we were only paying attention to measures of variance explained, we might be inclined to discount the importance of B1, treating it as a useful adjunct, since it only accounts around a third of the variance of A1. The predicted values of the probabilities, however, show the B1 makes a substantial contribution.

Setting aside questions of whether the findings can be generalize, which arise for any recommendations based on historical data, the practical recommendations suggested by the findings would note the larger contribution from A1 and the smaller contribution of B1, probably also noting that B1 by itself appears inadequate, since it only raises the probability of D1 occurring to about half. Both A1 and B1 occurring, however, gives a relatively high probability, and since the two are independent, even if one does not happen the chances of doing the other are not affected. In any case, C can be ignored.

But these findings leave a lot out:
1. The combination of A1 and B1 only occur on one of the eight paths that lead to D1. Seven eights of the ways things happen are out of the model. This single path accounts for 39% of what happens, and 47% of the probability of D1.
2. A1 alone only occur on half the paths. For this reason alone half of the ways things happen are left out of the model.
3. The path that is the second most likely way to reach D1 (in a two way tie) begins A2, B1 (Path 9). There is nothing in the model to suggest this possibility.
4. If A1 occurs and B1 does not, C makes a difference, as shown in the Situation Map example. (Paths 5 through 8). There is nothing in the model to suggest this possibility.
5. The probabilities estimated by the regression model are the probabilities when all the variables are still in play. Once events have happened, such as A1 or A2 at the beginning of the tree, the probabilities of the outcome change. (If A1 occurs it goes up, if A2 down, and so on.) Unlike a Probability Map, the model only gives an estimate of the probabilities when all the variables are still in play. Of the fifteen situations on paths to D, starting from before A, the model only covers one. Separate models would have to be build for each situation.

It would be much harder to clarify what correlation/regression leaves out without the PM to refer to, and in a way this is the point. Correlation/regression produces abstractions, but abstractions from what? The specifics are never visible except anecdotally—in effect, by observing fragments of the PM. So it is hard to be clear about what the abstractions sacrifice, and correspondingly easier to trust them since you never know what you've lost.

Other embodiments will occur to those skilled in the art and are in accordance with the claimed invention.

What is claimed is:

1. A computer-implemented method of modeling and analyzing disjunctive systems, especially systems containing human behaviors, comprising:
providing information relating to the behavior comprising a number of discrete variables each comprising at least two alternative states;
creating from the information a model that defines paths comprising a series of steps from one variable state to another to one or more outcomes;
assigning probabilities to the steps of the paths;
storing the model, including the assigned probabilities, in an electronic database; and
using a computer processor to determine the cumulative effect of the paths on the probability of outcomes.

2. The method of claim 1 further comprising segmenting continuous variables to produce discrete variables for the model.

3. The method of claim 1 further comprising adding to the model the complement of one or more variables adding a variable state that does not reflect measured or identified quantities in the data.

4. The method of claim 1 in which the database is a relational database.

5. The method of claim 4 further comprising adding to the database additional records related to one or more variables.

6. The method of claim 1 in which assigning probabilities comprises determining how many times one variable state directly follows another variable state or sequence of variable states and dividing by the number of occurrences of the previous state or sequence.

7. The method of claim 6 in which assigning probabilities further comprises determining the conditional probability of a variable based on the directly preceding variable states on a path, to model the effects of events in a particular sequence.

8. The method of claim 7 in which the probability of a path is the product of all of the probabilities along the path.

9. The method of claim 8 in which the probability of an outcome is the sum of the probabilities of all of the paths that lead to the outcome.

10. The method of claim 1 further comprising querying the database to find paths that fulfill the requirements of a logical statement comprising two or more variables.

11. The method of claim 1 further comprising allowing selection of the variables for the database query.

12. The method of claim 1 further comprising identifying a particular outcome and in response identifying each path that leads to that outcome.

13. The method of claim 12 further comprising reporting the identified paths and one or more of the path's individual and cumulative and rank ordered contributions to the probability of the outcome.

14. The method of claim 13 in which the report comprises a graph.

15. The method of claim 1 further comprising determining the likelihood of a path to produce the path's outcome and rank order those paths by likelihood.

16. The method of claim 1 further comprising determining the probability of an outcome given a particular variable state.

17. The method of claim 1 further comprising determining the overall gain or loss in outcome probability if a variable occurs compared to the previous variable.

18. The method of claim 1 further comprising determining the overall gain or loss in outcome probability if a variable state occurs compared to the variable state's complement.

19. The method of claim 1 further comprising determining the sum of the probabilities of the paths on which a particular variable lies.

20. The method of claim 1 further comprising determining the paths on which the complement of a particular variable state lies.

21. The method of claim 1 further comprising determining the value, in monetary or other utilities of an outcome.

22. The method of claim 21 in which the value is determined by relating a monetary value with one or more variables.

23. The method of claim 1 further comprising providing a comprehensive description of the probability relationships in the data.

24. The method of claim 1 further comprising defining individual variables states by the context provided by the other variables states on the same path.

25. The method of claim 1 further comprising providing data for agent based simulations and other simulations and sensitivity tests.
